(19) United States
(12) Patent Application Publication
(10) Pub. No.: US 2021/0242481 A1
(43) Pub. Date: Aug. 5, 2021

(54) POLYMER ELECTROLYTE MEMBRANE, MANUFACTURING METHOD THEREFOR, AND MEMBRANE ELECTRODE ASSEMBLY COMPRISING SAME

(71) Applicant: KOLON INDUSTRIES, INC., Seoul (KR)

(72) Inventors: Na Young KIM, Seoul (KR); Moo Seok LEE, Seoul (KR); Dong Hoon LEE, Seoul (KR); Eun Su LEE, Seoul (KR); Seung Jib YUM, Seoul (KR); Jung Hwa PARK, Seoul (KR)

(21) Appl. No.: 16/972,272

(22) PCT Filed: Jun. 28, 2019
(86) PCT No.: PCT/KR2019/007904

§ 371 Date: Dec. 4, 2020

(30) Foreign Application Priority Data
Jun. 29, 2018 (KR) 10-2018-0076004

(51) Int. Cl. H01M 8/1062; H01M 8/1004; H01M 8/1053; H01M 8/1067; H01M 8/1081

(52) U.S. Cl. CPC H01M 8/1062; H01M 8/1004; H01M 2008/1095; H01M 8/1067; H01M 8/1081; H01M 8/1053

(57) ABSTRACT

The present invention relates to a polymer electrolyte membrane, a manufacturing method therefor, and a membrane electrode assembly comprising same, the polymer electrolyte membrane comprising: a first porous support having first pores filled with a first ion conductor; and a second porous support having at least one second pore filled with the first ion conductor and third pores filled with a second ion conductor, wherein the first and second porous supports are in contact with each other. The polymer electrolyte membrane has enhanced performance through the improvement of impregnation properties and enhanced mechanical and chemical durability through the minimization of hydrogen permeability and dimensional change. Furthermore, an interface between the ion conductor and the support in the polymer electrolyte membrane can be stably maintained for a long time.

### TECHNICAL FIELD

The present disclosure relates to a polymer electrolyte membrane, a method of manufacturing the same, and a membrane-electrode assembly including the same, and more particularly to a polymer electrolyte membrane configured such that impregnation of the polymer electrolyte membrane is improved, whereby performance of the polymer electrolyte membrane is improved, hydrogen crossover and dimensional change of the polymer electrolyte membrane are minimized, whereby mechanical and chemical durabilities of the polymer electrolyte membrane are improved, and the interface between an ion conductor and a support is stably maintained for a long time, a method of manufacturing the same, and a membrane-electrode assembly including the same.

### BACKGROUND ART

A fuel cell, which is a cell including a power generation system for directly converting chemical reaction energy into electrical energy through an oxidation/reduction reaction of hydrogen and oxygen contained in a hydrocarbon-based fuel material, such as methanol, ethanol, or natural gas, has attracted attention as a next-generation clean energy source that is capable of replacing fossil energy due to the environmentally friendly characteristics thereof, such as high energy efficiency and reduced discharge of contaminants.

Such a fuel cell has an advantage in that unit cells are stacked to constitute a stack, whereby it is possible to provide various levels of power. In addition, the fuel cell has energy density 4 to 10 times that of a small-sized lithium battery, whereby the fuel cell has attracted attention as a small-sized power source or a mobile power source.

The stack of the fuel cell, which substantially generates electricity, has a structure in which several to several tens of unit cells, each of which includes a membrane-electrode assembly (MEA) and a separator (also referred to as a bipolar plate), are stacked, and the membrane-electrode assembly is generally configured to have a structure in which an oxidation electrode (an anode or a fuel electrode) and a reduction electrode (a cathode or an air electrode) are formed at opposite sides of an electrolyte membrane with the electrolyte membrane disposed therebetween.

The fuel cell may be classified as an alkaline electrolyte membrane fuel cell or a polymer electrolyte membrane fuel cell (PEMFC) depending on the state and kind of an electrolyte. The polymer electrolyte membrane fuel cell has attracted attention as a mobile power source, a power source for vehicles, and a power source for home use due to a low operating temperature lower than 100° C., rapid starting and response characteristics, and excellent durability thereof.

Representative examples of the polymer electrolyte membrane fuel cell may include a proton exchange membrane fuel cell (PEMFC), which uses hydrogen gas as fuel, and a direct methanol fuel cell (DMFC), which uses liquid methanol as fuel.

The reaction that occurs in the polymer electrolyte membrane fuel cell will be described in brief. First, when fuel such as hydrogen gas is supplied to the oxidation electrode, protons (H⁺) and electrons (e⁻) are generated at the oxidation electrode as the result of the oxidation reaction of hydrogen. The generated protons are transferred to the reduction electrode via a polymer electrolyte membrane, and the generated electrons are transferred to the reduction electrode via an external circuit. Oxygen is supplied from the reduction electrode, and the oxygen is bonded with the protons and the electrons, whereby water is generated through the reduction reaction of the oxygen.

Meanwhile, there are many technical problems to be solved in order to realize commercial use of the polymer electrolyte membrane fuel cell and, in particular, it is necessary to realize high performance, a long lifespan, and a reduction in the price of the polymer electrolyte membrane fuel cell. The element that exerts the greatest influence thereon is the membrane-electrode assembly and, in particular, the polymer electrolyte membrane is one of the core factors that exert the greatest influence on the performance and price of the MEA.

The requirements of the polymer electrolyte membrane necessary to operate the polymer electrolyte membrane fuel cell include high proton conductivity, high mechanical and chemical stability, high heat resistance, low fuel permeability, high mechanical strength, low moisture content, and excellent dimensional stability. A conventional polymer electrolyte membrane tends not to normally realize high performance under specific temperature and relative-humidity environments, particularly under high-temperature/low-humidity conditions. As a result, a polymer electrolyte membrane fuel cell having the conventional polymer electrolyte membrane applied thereto is limited in the range within which the fuel cell is capable of being employed.

In order to simultaneously secure the performance, durability, mechanical properties, and chemical properties of the polymer electrolyte membrane, a reinforced composite-membrane-type polymer electrolyte membrane having a reinforcement material applied thereto has been developed. However, a polymer electrolyte membrane having high proton conductivity has a shortcoming in that moisture content is high, whereby dimensional stability is reduced. A commercialized fluorine-based electrolyte membrane has higher performance than a hydrocarbon-based electrolyte membrane but has shortcomings in that open circuit voltage (OCV) is reduced and durability of the membrane is reduced due to high hydrogen conductivity thereof.

In order to commercialize a polymer electrolyte membrane, therefore, it is necessary to improve dimensional stability of the polymer electrolyte membrane at the time of impregnation and drying while improving performance thereof and thus to improve mechanical durability thereof. To this end, it is necessary to secure the optimum structure of a reinforced composite membrane and to improve impregnation thereof.

### DISCLOSURE

### Technical Problem

It is an object of the present disclosure to provide a polymer electrolyte membrane configured such that impregnation of the polymer electrolyte membrane is improved, whereby performance of the polymer electrolyte membrane is improved, hydrogen crossover and dimensional change of the polymer electrolyte membrane are minimized, whereby mechanical and chemical durabilities of the polymer electrolyte membrane are improved, and the interface between an ion conductor and a support is stably maintained for a long time.

It is another object of the present disclosure to provide a method of manufacturing the polymer electrolyte membrane.

It is a further object of the present disclosure to provide a membrane-electrode assembly including the polymer electrolyte membrane.

### Technical Solution

In accordance with an aspect of the present disclosure, there is provided a polymer electrolyte membrane including a first porous support having first pores filled with a first ion conductor and a second porous support having at least one second pore filled with the first ion conductor and third pores filled with a second ion conductor, wherein the first and second porous supports are in contact with each other.

All pores of the first porous support may be filled with the first ion conductor.

The first porous support may further have at least one fourth pore filled with the second ion conductor.

Each of the first and second porous supports may be an isotropic porous support configured such that machine-direction (MD) tensile elongation and transverse-direction (TD) tensile elongation are equal to each other or the higher of the MD tensile elongation and the TD tensile elongation is 1.5 times or less the lower thereof.

The first and second porous supports may be stacked such that directions in which the first and second porous supports have been drawn are perpendicular to each other.

In accordance with another aspect of the present disclosure, there is provided a polymer electrolyte membrane including a porous support and an ion conductor with which pores of the porous support are filled, wherein, at a temperature of 80° C. and a relative humidity (RH) of 50%, the polymer electrolyte membrane has an in-plane (IP) proton conductivity of 0.046 S/cm to 0.1 S/cm and a through-plane (TP) proton conductivity of 0.042 S/cm to 0.1 S/cm, and each of the MD swelling ratio and the TD swelling ratio of the polymer electrolyte membrane calculated by Equation 1 and Equation 2 below after the polymer electrolyte membrane is immersed in distilled water of room-temperature for 12 hours and then dried in a vacuum state at 50° C. for 24 hours is 2% or less.

ΔL(MD)=[(L_{wet}(MD)−L_{dry}(MD))/L_{dry}(MD)]×100 [Equation 1]

ΔL(TD)=[(L_{wet}(TD)−L_{dry}(TD))/L_{dry}(TD)]×100 [Equation 2]

where ΔL(MD) is an MD swelling ratio, ΔL(TD) is a TD swelling ratio, L_{wet}(MD) and L_{wet}(TD) are an MD length and a TD length measured immediately before the drying, respectively, and L_{dry}(MD) and L_{dry}(TD) are an MD length and a TD length measured immediately after the drying, respectively.

The TP proton conductivity and the IP proton conductivity of the polymer electrolyte membrane may be equal to each other, or the higher of the TP proton conductivity and the IP proton conductivity may be 1.5 times or less the lower thereof.

The TP swelling ratio and the MD swelling ratio may be equal to each other, or the higher of the TP swelling ratio and the MD swelling ratio may be 1.5 times or less the lower thereof.

The polymer electrolyte membrane may have a hydrogen crossover of 7×10⁻⁵ cm²/sec or less at a temperature of 65° C. and a relative humidity (RH) of 50%.

The MD tensile strength and the TD tensile strength of the polymer electrolyte membrane may be equal to each other, or the higher of the MD tensile strength and the TD tensile strength may be 1.5 times or less the lower thereof.

The MD tensile elongation and the TD tensile elongation of the polymer electrolyte membrane may be equal to each other, or the higher of the MD tensile elongation and the TD tensile elongation may be 1.5 times or less the lower thereof.

In accordance with another aspect of the present disclosure, there is provided a method of manufacturing a polymer electrolyte membrane, the method including casting a first mixed liquid including a first ion conductor, placing a first porous support of a dry state on the first mixed liquid such that the first porous support is entirely brought into a wet state, adding a second porous support of a dry state on the first porous support immediately after the first porous support is entirely brought into the wet state such that the first and second porous supports are in contact with each other, applying a second mixed liquid including a second ion conductor onto the second porous support such that the second porous support is entirely brought into a wet state, and drying the first and second porous supports of the wet state.

In accordance with another aspect of the present disclosure, there is provided a membrane-electrode assembly including an anode and a cathode, located opposite each other, and the polymer electrolyte membrane, located between the anode and the cathode.

In accordance with a further aspect of the present disclosure, there is provided a fuel cell including the membrane-electrode assembly.

### Advantageous Effects

Impregnation of a polymer electrolyte membrane according to the present disclosure is improved, whereby performance of the polymer electrolyte membrane is improved, hydrogen crossover and dimensional change of the polymer electrolyte membrane are minimized, whereby mechanical and chemical durabilities of the polymer electrolyte membrane are improved, and the interface between an ion conductor and a support is stably maintained for a long time.

### DESCRIPTION OF DRAWINGS

FIG. 1 is an exploded perspective view illustrating the case in which porous supports according to the present disclosure are stacked in an intersection direction.

FIG. 2 is a coupled perspective view of FIG. 1.

FIG. 3 is a sectional view schematically showing an example of a polymer electrolyte membrane according to an embodiment of the present disclosure.

FIGS. 4 and 5 are scanning electron microscopy (SEM) photographs of polymer electrolyte membranes manufactured according to Example 1 of the present disclosure and Comparative Example 1, respectively.

### MODE FOR INVENTION

Hereinafter, embodiments of the present disclosure will be described in detail with reference to the accompanying drawings such that the embodiments of the present disclosure can be easily implemented by a person having ordinary skill in the art to which the present disclosure pertains. However, the present disclosure may be realized in various different forms, and is not limited to the embodiments described herein.

A polymer electrolyte membrane according to an embodiment of the present disclosure includes a first porous support having first pores filled with a first ion conductor and a second porous support having at least one second pore filled with the first ion conductor and third pores filled with a second ion conductor, wherein the first and second porous supports are in contact with each other.

Optionally, the polymer electrolyte membrane according to the present disclosure may further include one or more porous supports stacked on any one of the first and second porous supports. That is, the polymer electrolyte membrane according to the present disclosure includes a stacked type porous support having a structure in which two or more porous supports are stacked.

According to the present disclosure, individual porous supports constituting the stacked type porous support are in tight contact with each other. Unless the individual porous supports are different in kind from each other so as to be distinguished from each other, the interface therebetween may not be visually recognized, and the stacked type porous support may not be an apparent single porous support. When viewing from the viewpoint of a final product, rather than the viewpoint of a manufacturing process, therefore, the stacked type porous support according to the present disclosure may be considered to be a single porous support depending on circumstances.

However, features related to the use of the stacked type porous support and a manufacturing method according to the present disclosure related therewith provide various advantages in terms of various physical properties of a polymer electrolyte membrane compared to the case in which a single porous support having the same thickness as the stacked type porous support is used, a detailed description of which will follow.

In the embodiment of the present disclosure, all pores of the first porous support may be filled with the first ion conductor. Alternatively, the first porous support may further have at least one fourth pore filled with the second ion conductor.

Each of the first and second porous supports may be an isotropic porous support configured such that machine-direction (MD) tensile elongation (hereinafter referred to as “MD tensile elongation”) and transverse-direction (TD) tensile elongation (hereinafter referred to as “TD tensile elongation”) are equal to each other or the higher of the MD tensile elongation and the TD tensile elongation is 1.5 times or less the lower thereof.

The first and second porous supports may be stacked such that the directions in which the first and second porous supports have been drawn are perpendicular to each other.

The thickness of the stacked type porous support may be 50% or more, specifically 50% to 90%, of the overall thickness of the polymer electrolyte membrane. In the case in which the thickness of the stacked type porous support is less than 50% of the overall thickness of the polymer electrolyte membrane, the effect of improvement in dimensional stability and mechanical durability of a reinforced composite membrane having the stacked type porous support as a reinforcement material may be insignificant. In the case in which the thickness of the stacked type porous support is greater than 90% of the overall thickness of the polymer electrolyte membrane, the thickness of an ion conductive layer located on the upper or lower surface of the stacked type porous support may be too small, whereby sheet resistance may increase.

The stacked type porous support is constituted by stacking a plurality of porous supports, and the surface area of the stacked type porous support that directly contacts an ion conductor during an impregnation process is increased, compared to the case in which a single porous support having the same thickness as the stacked type porous support is used, whereby wetting of the stacked type porous support due to a solution including the ion conductor may be improved. In addition, when pores of the porous supports are filled with the ion conductor, air in the pores may be more easily discharged therefrom, whereby generation of microscopic air bubbles may be minimized, and therefore impregnation may be improved. Such improvement in wetting and impregnation increases ion conductivity of the polymer electrolyte membrane according to the present disclosure. In addition, an area capable of buffering dimensional change may be increased, whereby dimensional stability may be improved.

In order to improve dimensional stability of a reinforced composite electrolyte membrane manufactured using only a single porous support, it is necessary to increase the thickness of the porous support. As the thickness of the porous support is increased, however, wetting and impregnation of the porous support are lowered, whereby ion conductivity of the electrolyte membrane is reduced. In the case in which the thickness of the porous support is reduced, on the other hand, ion conductivity of the electrolyte membrane may be increased due to improvement in wetting and impregnation; however, the function as a support is not properly performed, and therefore dimensional stability of the electrolyte membrane is reduced. That is, in a reinforced composite electrolyte membrane manufactured using only a single porous support, ion conductivity and dimensional stability are physical properties having a trade-off therebetween.

In the present disclosure, the stacked type porous support is adopted, and at the same time an impregnation process and a add-on process peculiar to the present disclosure are performed, whereby it is possible to improve both ion conductivity and dimensional stability of the polymer electrolyte membrane.

Specifically, a polymer electrolyte membrane manufactured using a manufacturing method according to the present disclosure includes a porous support and an ion conductor with which pores of the porous support are filled, wherein (i) at a temperature of 80° C. and a relative humidity (RH) of 50%, the polymer electrolyte membrane has an in-plane (IP) proton conductivity (hereinafter referred to as “IP proton conductivity”) of 0.046 S/cm to 0.1 S/cm and a through-plane (TP) proton conductivity (hereinafter referred to as “TP proton conductivity”) of 0.042 S/cm to 0.1 S/cm and (ii) each of the machine-direction (MD) swelling ratio (hereinafter referred to as “MD swelling ratio”) and the transverse-direction (TD) swelling ratio (hereinafter referred to as “TD swelling ratio”) of the polymer electrolyte membrane calculated by Equation 1 and Equation 2 below after the polymer electrolyte membrane is immersed in distilled water of room-temperature for 12 hours and then dried in a vacuum state at 50° C. for 24 hours is 2% or less.

ΔL(MD)=[(L_{wet}(MD)−L_{dry}(MD))/L_{dry}(MD)]×100 [Equation 1]

ΔL(TD)=[(L_{wet}(TD)−L_{dry}(TD))/L_{dry}(TD)]×100 [Equation 2]

where ΔL(MD) is an MD swelling ratio, ΔL(TD) is a TD swelling ratio, L_{wet}(MD) and L_{wet}(TD) are an MD length and a TD length measured immediately before the drying, respectively, and L_{dry}(MD) and L_{dry}(TD) are an MD length and a TD length measured immediately after the drying, respectively.

The machine direction (MD), which is a length direction, means a direction in which a roll advances when the polymer electrolyte membrane is continuously produced in a roll-to-roll fashion or a direction in which the manufactured polymer electrolyte membrane is wound, and the transverse direction (TD), which is a width direction, means a direction perpendicular to the machine direction.

In addition, as a method similar to the method of measuring the MD swelling ratio and the TD swelling ratio, the thickness T_{wet} of the polymer electrolyte membrane of a wet state and the thickness T_{dry} of the polymer electrolyte membrane of a dry state may be measured and substituted into Equation 3 below to calculate a thickness swelling ratio.

(T_{wet}−T_{dry}/T_{dry})×100=ΔT(thickness swelling ratio,%) [Equation 3]

The TD swelling ratio and the MD swelling ratio of the polymer electrolyte membrane may be equal to each other, or the higher of the TD swelling ratio and the MD swelling ratio may be 1.5 times or less the lower thereof. In the case in which the higher of the TD swelling ratio and the MD swelling ratio is greater than 1.5 times the lower thereof, resistances to swelling are different from each other in both directions, whereby mechanical durability of the polymer electrolyte membrane is abruptly reduced as moisturization and drying are repeatedly performed.

Also, in the case in which impregnation of the stacked type porous support is improved, a water channel along which protons are movable may be successfully formed in a through-plane direction of the stacked type porous support, whereby performance of the stacked type porous support may be improved. In addition, a flow channel along which hydrogen gas is movable may be complicated, whereby resistance may increase when the hydrogen gas moves and thus hydrogen crossover may be reduced. In the case in which the stacked type porous support is used, therefore, it is possible to secure chemical durability while securing high performance.

Consequently, the polymer electrolyte membrane according to the embodiment of the present disclosure may have an IP proton conductivity of 0.046 S/cm to 0.1 S/cm and a TP proton conductivity of 0.042 S/cm to 0.1 S/cm at a temperature of 80° C. and a relative humidity (RH) of 50%, and at the same time may have a hydrogen crossover of 7×10⁻⁵ cm²/sec or less at a temperature of 65° C. and a relative humidity (RH) of 50%. In the case in which the IP and TP proton conductivities of the polymer electrolyte membrane are less than the above-specified ranges, it is not possible to secure basic functions as the polymer electrolyte membrane. In the case in which the hydrogen crossover of the polymer electrolyte membrane is greater than 7×10⁻⁵ cm²/sec, OCV may be lowered and long-term chemical durability may be greatly lowered. As long as the polymer electrolyte membrane satisfies a predetermined level or more of proton conductivity, it is preferable that hydrogen crossover be lower. When considering the current technical limitations, however, the lower limit of hydrogen crossover of the polymer electrolyte membrane may be 1×10⁻⁸ cm²/sec.

In addition, the TP proton conductivity and the IP proton conductivity of the polymer electrolyte membrane may be equal to each other, or the higher of the TP proton conductivity and the IP proton conductivity may be 1.5 times or less, specifically 1.0 to 1.1 times, the lower thereof. That is, the stacked porous supports of the polymer electrolyte membrane may be in tight contact with each other to the extent to which the interface between the supports cannot be visually recognized, whereby impregnation may be improved and thus a through-plane (TP) water channel along which protons are movable may be more successfully formed, compared to other methods. This may be indicated by the ratio between the IP proton conductivity and the TP proton conductivity.

The in-plane (IP) direction of the polymer electrolyte membrane, which is a plane direction perpendicular to the through-plane (TP) direction, may mean one or both of the machine direction (MD) and the transverse direction (TD), which is perpendicular to the machine direction.

The IP proton conductivity may be calculated by using membrane resistance at a relative humidity of 50% after measuring membrane resistance at a temperature of 80° C. and a relative humidity of 30% to 95% using a magnetic suspension balance (Bell Japan Company). The TP proton conductivity may be measured by coating opposite surfaces of the polymer electrolyte membrane with Pt catalyst ink, placing and fastening a gas diffusion layer thereon, measuring membrane resistance at a temperature of 80° C. and a relative humidity of 50%, and dividing the measured membrane resistance by the thickness of the polymer electrolyte membrane. At this time, Equations 4 and 5 below may be used.

Membrane resistance(R)=(R₁−R₂)×(effective area of membrane) [Equation 4]

where R₁ is resistance [Ω] when a membrane is poured, and R₂ is resistance [Ω] when no membrane is poured.

Proton conductivity(S/cm)=1/R×t [Equation 5]

where R is membrane resistance [Ω·cm²], and t is the thickness of a membrane [cm].

The ratio between the IP proton conductivity and the TP proton conductivity may be calculated by dividing the higher of the IP proton conductivity and the TP proton conductivity by the lower thereof. For example, when the IP proton conductivity is less than the TP proton conductivity, the TP proton conductivity may be divided by the IP proton conductivity to obtain the ratio. On the other hand, when the TP proton conductivity is less than the IP proton conductivity, the IP proton conductivity may be divided by the TP proton conductivity to obtain the ratio.

If the ratio between the IP proton conductivity and the TP proton conductivity is greater than 1.5, the performance of a membrane-electrode assembly may be reduced, and the amount of hydrogen gas crossover through a non-impregnation area may be increased.

Also, when manufacturing the stacked type porous support by stacking the porous supports, the porous supports are not bonded to each other using an adhesive, and the porous supports are not bonded to each other by thermal compression, either. If the stacked type porous support includes an adhesive layer or is formed by thermal compression, proton conductivity is lowered, whereby performance is reduced. when manufacturing the stacked type porous support, therefore, one of the porous supports is added on the other while each of the porous supports is wetted with a solution including an ion conductor, whereby the interface at which the ion conductors join each other is located in any one of the porous supports and thus bonding strength is improved. Consequently, it is possible to add one of the porous supports on the other at high adhesive strength without causing a problem of performance reduction which otherwise might occur due to an additional adhesive layer.

Consequently, the ratio between machine-direction (MD) tensile strength and transverse-direction (TD) tensile strength of the polymer electrolyte membrane may be 1.0 to 1.5, specifically 1.0 to 1.2. The ratio between the machine-direction (MD) tensile elongation and the transverse-direction (TD) tensile elongation of the polymer electrolyte membrane may be 1.0 to 1.5, specifically 1.0 to 1.2.

The tensile strength and the tensile elongation may be measured by stretching a polymer electrolyte membrane having an area of 3 cm² in the machine direction (MD) or the transverse direction (TD) at a crosshead speed of 500 mm/sec using a 1 kN load cell. The MD tensile strength and the MD tensile elongation are measured by stretching the polymer electrolyte membrane in the machine direction, and the TD tensile strength and the TD tensile elongation are measured by stretching the polymer electrolyte membrane in the transverse direction.

The ratio between the MD tensile strength and the TD tensile strength and the ratio between the MD tensile elongation and the TD tensile elongation may be calculated by dividing a larger one thereof by a smaller one.

If the ratio between the MD tensile strength and the TD tensile strength and the ratio between the MD tensile elongation and the TD tensile elongation of the polymer electrolyte membrane are greater than 1.5, mechanical durability of the polymer electrolyte membrane may not be sufficiently improved due to the anisotropy thereof.

As an illustration, the porous support may include a highly fluorinated polymer having high resistance to thermal and chemical decomposition, preferably a perfluorinated polymer. For example, the porous support may be a copolymer of polytetrafluoroethylene (PTFE) or tetrafluoroethylene and CF₂═CFCₙF₂ₙ₊₁ (n being a real number ranging from 1 to 5) or CF₂═CFO—(CF₂CF(CF₃) O)ₘCₙF₂ₙ₊₁ (m being a real number ranging from 0 to 15 and n being a real number ranging from 1 to 15).

The PTFE is commercially available, and may be appropriately used as the porous support. In addition, expanded polytetrafluoroethylene (e-PTFE), which has a polymer fibril microstructure or a microstructure in which nodes are connected to each other via fibrils, may also be appropriately used as the porous support, and a film having a polymer fibril microstructure in which no nodes are present may also be appropriately used as the porous support.

The porous support including the perfluorinated polymer is formed by extruding dispersion-polymerized PTFE onto tape in the presence of a lubricant and drawing the same. Consequently, it is possible to manufacture a porous support having higher porosity and higher strength. In addition, the e-PTFE may be thermally treated at a temperature exceeding the melting point (about 342° C.) of the PTFE, whereby it is possible to increase the amorphous content ratio of PTFE. An e-PTFE film manufactured using the above method may have micropores having various diameters and porosities. The e-PTFE film manufactured using the above method may have a porosity of at least 35%, and the diameter of each of the micropores may be about 0.01 μm to 1 μm. In addition, the thickness of the porous support including the perfluorinated polymer may be variously changed. As an example, the thickness of the porous support may be 2 μm to 40 μm, preferably 5 μm to 20 μm. In the case in which the thickness of the porous support is less than 2 μm, the mechanical strength of the porous support may be remarkably reduced. In the case in which the thickness of the porous support is greater than 40 μm, on the other hand, the resistance loss of the porous support may be increased, the weight of the porous support may be increased, and integration of the porous support may be deteriorated.

As another illustration of the porous support, the porous support may be a nonwoven fibrous web including a plurality of fibers oriented at random.

The nonwoven fibrous web is a sheet that is interlaid but has a structure of individual fibers or filaments, rather than the same structure as woven cloth. The nonwoven fibrous web may be manufactured using a method selected from the group consisting of carding, garneting, air laying, wet laying, melt blowing, spun bonding, and stitch bonding.

The fiber may include one or more polymer materials. In general, any fiber-forming polymer material may be used. Specifically, a hydrocarbon-based fiber-forming polymer material may be used. For example, the fiber-forming polymer material may include, but is not limited to, polyolefin, such as polybutylene, polypropylene, or polyethylene; polyester, such as polyethylene terephthalate or polybutylene terephthalate; polyamide (nylon-6 or nylon-6,6); polyurethane; polybutene; polylactic acid; polyvinyl alcohol; polyphenylene sulfide; polysulfone; a liquid crystalline polymer; polyethylene-co-vinyl acetate; polyacrylonitrile; cyclic polyolefin; polyoxymethylene; a polyolefin-based thermoplastic elastomer; and a combination thereof.

As another illustration of the porous support having the form of the nonwoven fibrous web, the porous support may include a nanoweb in which nanofibers are integrated into the form of a nonwoven cloth including a plurality of pores.

A hydrocarbon-based polymer, which exhibits high chemical resistance and hydrophobicity, whereby the hydrocarbon-based polymer is prevented from being deformed by moisture in a high-humidity environment, is preferably used as the nanofibers. Specifically, the hydrocarbon-based polymer may be selected from the group consisting of nylon, polyimide, polyaramid, polyetherimide, polyacrylonitrile, polyaniline, polyethylene oxide, polyethylene naphthalate, polybutylene terephthalate, styrene-butadiene rubber, polystyrene, polyvinyl chloride, polyvinyl alcohol, polyvinylidene fluoride, polyvinyl butylene, polyurethane, polybenzoxazole, polybenzimidazole, polyamide imide, polyethylene terephthalate, polyphenylene sulfide, polyethylene, polypropylene, a copolymer thereof, and a mixture thereof. Thereamong, polyimide, which exhibits higher thermal resistance, chemical resistance, and shape stability, is preferably used.

The nanoweb is an aggregate of nanofibers in which nanofibers manufactured by electrospinning are randomly arranged. At this time, it is preferable for the nanofibers to have an average diameter of 40 nm to 5000 nm in consideration of the porosity and thickness of the nanoweb when the diameters of 50 fibers are measured using a scanning electron microscope (JSM6700F, JEOL) and the average of the diameters of the fibers is calculated. In the case in which the average diameter of the nanofibers is less than 40 nm, the mechanical strength of the porous support may be reduced. In the case in which the average diameter of the nanofibers is greater than 5000 nm, on the other hand, the porosity of the porous support may be remarkably deteriorated, and the thickness of the porous support may be increased.

The thickness of the nonwoven fibrous web may be 3 μm to 50 μm, specifically 3 μm to 20 μm. In the case in which the thickness of the nonwoven fibrous web is less than 3 μm, the mechanical strength of the nonwoven fibrous web may be reduced. In the case in which the thickness of the nonwoven fibrous web is greater than 50 μm, on the other hand, the resistance loss of the nonwoven fibrous web may be increased, the weight of the nonwoven fibrous web may be increased, and integration of the nonwoven fibrous web may be deteriorated.

The basic weight of the nonwoven fibrous web may range from 3 g/m² to 20 g/m². In the case in which the basic weight of the nonwoven fibrous web is less than 3 g/m², visible pores are formed in the nonwoven fibrous web, whereby it may be difficult to realize the function as the porous support. In the case in which the basic weight of the nonwoven fibrous web is greater than 20 g/m², the nonwoven fibrous web may be manufactured in the form of paper or textile, which has few pores formed therein.

The porosity of the porous support may be 45% or more, specifically 60% or more. Meanwhile, it is preferable for the porous support to have a porosity of 90% or less. In the case in which the porosity of the porous support is greater than 90%, the shape stability of the porous support may be deteriorated, whereby subsequent processes may not be smoothly carried out. The porosity of the porous support may be calculated using Equation 6 below based on the ratio of the volume of air to the overall volume of the porous support. At this time, the overall volume of the porous support may be calculated by manufacturing a rectangular sample and measuring the length, width, and thickness of the sample, and the volume of the air may be obtained by subtracting the volume of a polymer, back-calculated from the density thereof after measuring the mass of the sample, from the overall volume of the porous support.

Porosity (%)=(volume of air in porous support/overall volume of porous support)Δ100 [Equation 6]

The polymer electrolyte membrane is a reinforced composite-membrane-type polymer electrolyte membrane in which the pores in the porous support are filled with an ion conductor.

The porous supports constituting the stacked type porous support may be of the same kind, or may be of different kinds.

At this time, each of the porous supports may be an isotropic porous support having a ratio between the MD tensile elongation and the TD tensile elongation of 1.0 to 1.5, specifically 1.0 to 1.2.

In the case in which the isotropic porous supports are stacked, it is possible to minimize deviation in the ratio between the machine-direction tensile elongation and the transverse-direction tensile elongation and the dimensional variation of the stacked type porous support, whereby it is possible to overcome the shortcomings of a porous support manufactured using a drawing method and to further improve impregnation and dimensional stability.

The tensile elongation is measured by stretching a porous support having a width of 1 cm and a length of 5 cm in the machine direction (MD) or the transverse direction (TD) at a crosshead speed of 500 mm/sec using a 1 kN load cell. The ratio between the MD tensile elongation and the TD tensile elongation is calculated by dividing a larger one thereof by a smaller one.

In addition, the porous supports may be stacked in the same direction, or may be stacked in an intersection direction. For example, each of the porous supports may be drawn in any one of the machine direction (MD) and the transverse direction (TD) so as to have directivity, and the porous supports may be stacked such that the directions in which the porous supports have been drawn perpendicularly intersect each other.

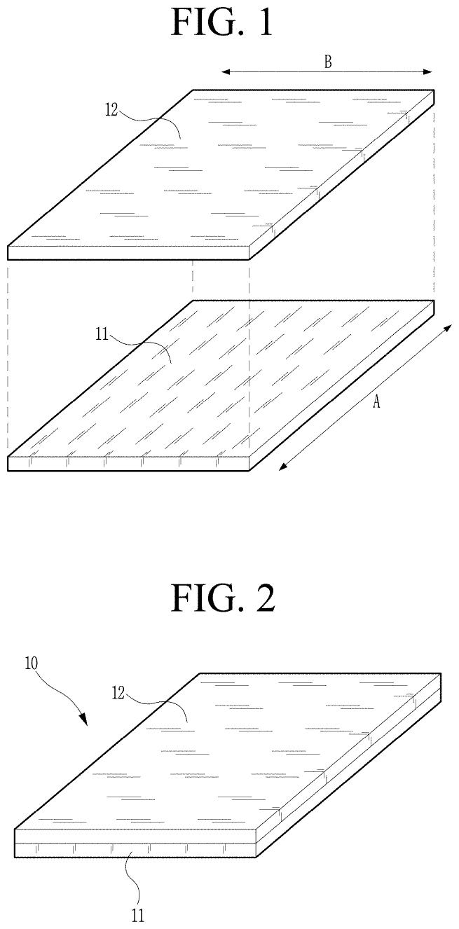

FIG. 1 is an exploded perspective view illustrating the case in which the porous supports are stacked in the intersection direction, and FIG. 2 is a coupled perspective view of FIG. 1. Referring to FIGS. 1 and 2, the first porous support 11 has been drawn in direction A, and the second porous support 12 has been drawn in direction B. At this time, the stacked type porous support 10 is configured such that the first porous support 11 and the second porous support 12 are stacked in such a way that direction A and direction B perpendicularly intersect each other.

In addition, the mechanical properties, such as the tensile strength and the tensile elongation, of each of the porous supports in any one of the machine direction and the transverse direction may be higher, and the porous supports may be stacked such that the directions in which the mechanical properties thereof are higher perpendicularly intersect each other.

In the case in which the porous supports are stacked in the intersection direction, as described above, it is possible to minimize deviation in the ratio between the machine-direction tensile elongation and the transverse-direction tensile elongation and the dimensional variation of the stacked type porous support, even though the above isotropic porous supports are not used, whereby it is possible to overcome the shortcomings of a porous support manufactured using a drawing method and to further improve impregnation and dimensional stability. More particularly, although the ratio between the MD tensile elongation and the TD tensile elongation of each of the porous supports stacked in the intersection direction may be greater than 1.5, the ratio between the MD tensile elongation and the TD tensile elongation of the stacked type porous support may be 1.0 to 1.5 as the result of the intersection stacking.

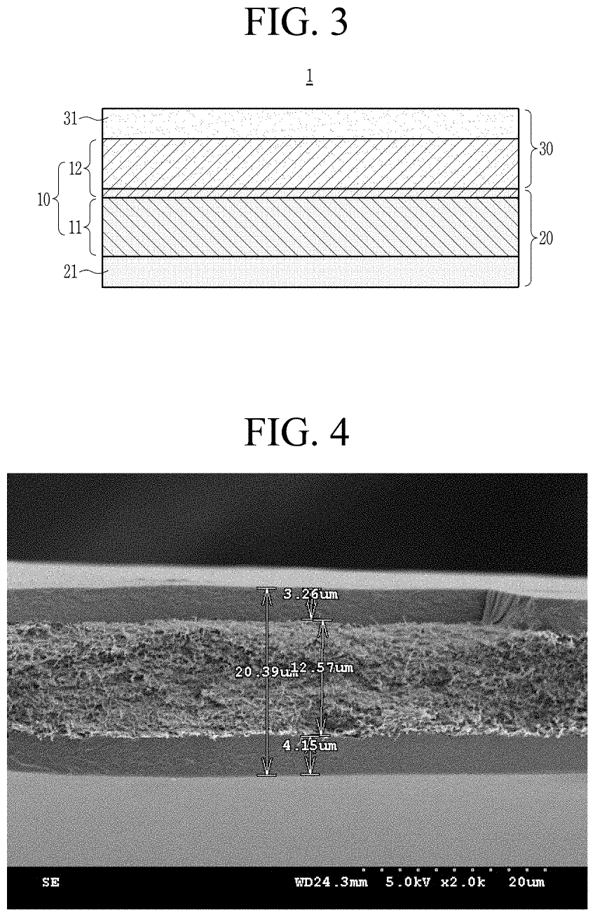

FIG. 3 is a sectional view schematically showing an example of the polymer electrolyte membrane. Referring to FIG. 3, the stacked type porous support 10 includes a first porous support 11 and a second porous support 12, wherein first pores of the first porous support 11 are filled with a first ion conductor 20, and third pores of the second porous support 12 are filled with a second ion conductor 30. In addition, a first ion conductor layer 21 is located on the outer surface of the first porous support 11, and a second ion conductor layer 13 is located on the outer surface of the second porous support 12.

The interface at which the first ion conductor 20 and the second ion conductor 30 join each other may be located in any one of the porous supports 11 and 12. In FIG. 3, the interface at which the first ion conductor 20 and the second ion conductor 30 join each other is shown as being located in the second porous support 12. That is, the second porous support 12 has at least one second pore filled with the first ion conductor 20.

The polymer electrolyte membrane according to the present disclosure has improved bonding strength between the porous supports since, when manufactured, one of the porous supports is added on the other porous support while the one of the porous supports has been wetted with a solution including an ion conductor, whereby the ion conductor can permeate into the other porous support.

In addition, according to the present disclosure, the polymer electrolyte membrane includes no ion conductor layer between the stacked porous supports.

That is, the polymer electrolyte membrane includes a stacked type porous support manufactured by adding one of the porous supports on the other porous support while the one of the porous supports has been wetted with a solution including an ion conductor. Consequently, the polymer electrolyte membrane according to the present disclosure is different from a stacked type polymer electrolyte membrane, which is manufactured by respectively wetting porous supports with a solution including an ion conductor, respectively drying them to manufacture a plurality of polymer electrolyte membranes, and then stacking them, in that no ion conductor layer is included between the stacked porous supports.

That is, in the stacked type polymer electrolyte membrane, a first ion conductor layer formed on the surface of a first porous support and a second ion conductor layer formed on the surface of a second porous support are contacted and laminated with each other at the time of stacking the polymer electrolyte membranes, whereby a thick ion conductor layer is formed between the porous supports. In the case of the polymer electrolyte membrane according to the present disclosure, on the other hand, the porous supports are in direct contact with each other.

Consequently, impregnation of the polymer electrolyte membrane according to the present disclosure may be improved, whereby a water channel along which protons are movable may be successfully formed in the through-plane direction of the stacked type porous support, and therefore performance of the polymer electrolyte membrane may be improved. In addition, a flow channel along which hydrogen gas is movable may be complicated, whereby resistance may increase when the hydrogen gas moves and thus hydrogen crossover may be reduced. In the case of the stacked type polymer electrolyte membrane, however, a flow channel along which hydrogen gas is movable is not complicated, whereby it is not possible to obtain the effect of reducing hydrogen crossover due to an increase in resistance when the hydrogen gas moves.

Each of the first and second ion conductors may independently be a cation conductor having a cation exchange group that is capable of transferring cations, such as protons, or an anion conductor having an anion exchange group that is capable of transferring anions, such as hydroxyl ions, carbonate, or bicarbonate.

The cation exchange group may be any one selected from the group consisting of a sulfonic acid group, a carboxyl group, a boronic acid group, a phosphate group, an imide group, a sulfonimide group, a sulfonamide group, a sulfonic acid fluoride group, and a combination thereof. In general, the cation exchange group may be a sulfonic acid group or a carboxyl group.

The cation conductor may be a fluorine-based polymer having the cation exchange group and including fluorine in the main chain thereof; a hydrocarbon-based polymer, such as benzimidazole, polyamide, polyamide imide, polyimide, polyacetal, polyethylene, polypropylene, acrylic resin, polyester, polysulfone, polyether, polyether imide, polyester, polyether sulfone, polyether imide, polycarbonate, polystyrene, polyphenylene sulfide, polyether ether ketone, polyether ketone, polyaryl ether sulfone, polyphosphazene, or polyphenyl quinoxaline; a partially fluorinated polymer, such as a polystyrene-graft-ethylene tetrafluoroethylene copolymer or a polystyrene-graft-polytetrafluoroethylene copolymer; or sulfonyl imide.

More specifically, in the case in which the cation conductor is a proton conductor, each of the polymers may include a cation exchange group selected from the group consisting of a sulfonic acid group, a carboxylic acid group, a phosphate group, a phosphonic acid group, and a derivative thereof in the side chain thereof. As a concrete example, the cation conductor may be, but is not limited to, a fluorine-based polymer including poly(perfluorosulfonic acid), poly(perfluorocarboxylic acid), a copolymer of tetrafluoroethylene and fluoro vinyl ether including a sulfonic acid group, defluorinated polyetherketone sulfide, and a mixture thereof; or a hydrocarbon-based polymer including sulfonated polyimide (S-PI), sulfonated polyarylether sulfone (S-PAES), sulfonated polyetheretherketone (SPEEK), sulfonated polybenzimidazole (SPBI), sulfonated polysulfone (S-PSU), sulfonated polystyrene (S-PS), sulfonated polyphosphazene, sulfonated polyquinoxaline, sulfonated polyketone, sulfonated polyphenylene oxide, sulfonated polyether sulfone, sulfonated polyether ketone, sulfonated polyphenylene sulfone, sulfonated polyphenylene sulfide, sulfonated polyphenylene sulfide sulfone, sulfonated polyphenylene sulfide sulfone nitrile, sulfonated polyarylene ether, sulfonated polyarylene ether nitrile, sulfonated polyarylene ether ether nitrile, sulfonated polyarylene ether sulfone ketone, and a mixture of thereof.

The anion conductor is a polymer capable of transporting anions, such as hydroxyl ions, carbonate, or bicarbonate. The anion conductor is commercially available in the form of hydroxide or halide (generally chloride), and the anion conductor may be used in an industrial v/ater purification, metal separation, or catalyst process.

A polymer doped with metal hydroxide may generally be used as the anion conductor. Specifically, poly(ether sulfone), polystyrene, a vinyl-based polymer, poly(vinyl chloride), poly(vinylidene fluoride), poly(tetrafluoroethylene), poly(benzimidazole), or poly(ethylene glycol), doped with metal hydroxide, may be used as the anion conductor.

Meanwhile, any one selected from the group consisting of the stacked type porous support, the first ion conductor layer, and the second ion conductor layer may further include an antioxidant.

Since a reduction reaction of oxygen at a cathode of a polymer electrolyte membrane fuel cell is performed via hydrogen peroxide (H₂O₂), hydrogen peroxide may be generated at the cathode, or a hydroxyl radical (OH⁻) may be generated from the generated hydrogen peroxide. In addition, as oxygen molecules are transmitted through the polymer electrolyte membrane at an anode of the polymer electrolyte membrane fuel cell, the hydrogen peroxide or hydroxyl radical may also be generated at the anode. The generated hydrogen peroxide or hydroxyl radical deteriorates a polymer including a sulfonic acid group included in the polymer electrolyte membrane or the catalyst electrode.

Consequently, an antioxidant capable of decomposing the peroxide or radical may be included in order to inhibit the generation of radicals from the peroxide or to decompose the generated radicals, whereby it is possible to prevent the deterioration of the polymer electrolyte membrane or the catalyst electrode and thus to improve the chemical durability of the polymer electrolyte membrane.

The kind of the antioxidant capable of decomposing the peroxide or radical is not particularly restricted and any kind of antioxidant is usable in the present disclosure, as long as it is possible to rapidly decompose a peroxide (particularly, hydrogen peroxide) or a radical (particularly, a hydroxyl radical) generated during the operation of the polymer electrolyte membrane fuel cell. Specifically, for example, the antioxidant capable of decomposing the peroxide or radical may be configured in the form of a transition metal capable of decomposing the peroxide or radical, a noble metal capable of decomposing the peroxide or radical, an ion thereof, a salt thereof, or an oxide thereof.

Specifically, the transition metal capable of decomposing the peroxide or radical may be any one selected from the group consisting of cerium (Ce), nickel (Ni), tungsten (W), cobalt (Co), chromium (Cr), zirconium (Zr), yttrium (Y), manganese (Mn), iron (Fe), titanium (Ti), vanadium (V), molybdenum (Mo), lanthanum (La), and neodymium (Nd).

In addition, the noble metal capable of decomposing the peroxide or radical may be any one selected from the group consisting of silver (Au), platinum (Pt), ruthenium (Ru), palladium (Pd), and rhodium (Rh).

In addition, the ion of the transition metal or the noble metal capable of decomposing the peroxide or radical may be any one selected from the group consisting of a cerium ion, a nickel ion, a tungsten ion, a cobalt ion, a chromium ion, a zirconium ion, an yttrium ion, a manganese ion, an iron ion, a titanium ion, a vanadium ion, a molybdenum ion, a lanthanum ion, a neodymium ion, a silver ion, a platinum ion, a ruthenium ion, a palladium ion, and a rhodium ion. Specifically, in the case of cerium, a trivalent cerium ion (Ce³⁺) or a tetravalent cerium ion (Ce⁴⁺) may be used.

In addition, the oxide of the transition metal or the noble metal capable of decomposing the peroxide or radical may be any one selected from the group consisting of cerium oxide, nickel oxide, tungsten oxide, cobalt oxide, chromium oxide, zirconium oxide, yttrium oxide, manganese oxide, iron oxide, titanium oxide, vanadium oxide, molybdenum oxide, lanthanum oxide, and neodymium oxide.

In addition, the salt of the transition metal or the noble metal capable of decomposing the peroxide or radical may be any one selected from the group consisting of carbonate, acetate, chloride salt, fluoride salt, sulfate, phosphate, tungstate, hydrate, ammonium acetate, ammonium sulfate, and acetylacetonate of the transition metal or the noble metal. Specifically, in the case of cerium, cerium carbonate, cerium acetate, cerium chloride, cerium nitrate, cerium sulfate, ammonium cerium (II) nitrate, or ammonium cerium (IV) sulfate may be used, and cerium acetylacetonate may be used as organic metal complex salt.

Meanwhile, in order to prevent elution of the antioxidant during operation of the fuel cell, an organic-based second antioxidant capable of fixing the antioxidant may be included.

The organic-based second antioxidant may be a compound including a resonance structure based on a double bond of carboxyl acid, a hydroxyl group, and carbon. The organic-based second antioxidant having this structure has a larger molecular size than an ion cluster and a channel in the polymer electrolyte membrane, whereby elution may be prevented due to the size of molecules that cannot use an elution path and through a hydrogen bond between a large amount of carboxyl acid and a hydroxyl group included in the organic-based second antioxidant and the polymer in the polymer electrolyte membrane.

A concrete example of the organic-based second antioxidant may be any one selected from the group consisting of syringic acid, vanillic acid, protocatechuic acid, coumaric acid, caffeic acid, ferulic acid, chlorogenic acid, cynarine, gallic acid, and a mixture thereof.

In the case in which the antioxidant includes both a first antioxidant and a second antioxidant, the second antioxidant may be included so as to account for 0 to 200 parts by weight, specifically 30 to 100 parts by weight, based on 100 parts by weight of the first antioxidant. In the case in which the content of the second antioxidant is less than 30 parts by weight, oxidation prevention similar to the case in which only the first antioxidant is used may be achieved, whereby it is difficult to obtain the effect of introducing the second antioxidant. In the case in which the content of the second antioxidant is greater than 200 parts by weight, dispersibility of the polymer in the polymer electrolyte membrane may be deteriorated, whereby uniformity of the entire polymer electrolyte membrane may be reduced.

A method of manufacturing a polymer electrolyte membrane according to another embodiment of the present disclosure includes a step of casting a first mixed liquid including a first ion conductor, a step of placing a first porous support of a dry state on the first mixed-liquid such that the first porous support is entirely brought into a wet state, a step of adding a second porous support of a dry state on the first porous support immediately after the first porous support is entirely brought into the wet state such that the first and second porous supports are in contact with each other, a step of applying a second mixed liquid including a second ion conductor to the second porous support such that the second porous support is entirely brought into a wet state, and a step of drying the first and second porous supports of the wet state.

The step of applying the second mixed liquid including the second ion conductor to the second porous support such that the second porous support is entirely brought into the wet state may be performed by (i) if the first ion conductor and the second ion conductor are the same, adding the second porous support on the first porous support and then immersing or impregnating both the first and second porous supports in or with the second mixed liquid, or (ii) coating the exposed surface of the second porous support with the second mixed liquid. Coating with the second mixed liquid may be performed by bar coating, comma coating, slot die coating, screen printing, spray coating, doctor blade coating, or laminating.

The first/second mixed liquid may be a solution or a dispersion liquid containing the first/second ion conductor. Meanwhile, the antioxidant may be further added to the first and/or second mixed liquid. A description of the antioxidant is identical to the above description, and therefore a repetitive description thereof will be omitted.

A solvent or a dispersion medium for manufacturing the first and second mixed liquids may be water, a hydrophilic solvent, an organic solvent, or a mixture of two or more thereof

The hydrophilic solvent may have at least one functional group selected from the group consisting of alcohol, isopropyl alcohol, ketone, aldehyde, carbonate, carboxylate, carboxylic acid, ether, and amide, each of which includes straight-chain or branched-chain saturated or unsaturated hydrocarbon having a carbon number ranging from 1 to 12 as the main chain thereof. Each thereof may include an alicyclic or aromatic cyclic compound as at least a portion of the main chain thereof.

The organic solvent may be selected from among N-methylpyrrolidone, dimethyl sulfoxide, tetrahydrofuran, and a mixture thereof.

Meanwhile, a step of filling pores in the stacked type porous support with the first ion conductor or the second ion conductor may be affected by various factors, such as temperature and time. For example, the filling step may be affected by the thickness of the stacked type porous support, the concentration of the mixed liquid including the first or second ion conductor, and the kind of the solvent/dispersion medium. However, the process may be performed at a temperature equal to or higher than the freezing point of the solvent/dispersion medium and equal to or less than 100° C. More generally, the process may be performed at a temperature ranging from room temperature (20° C.) to 70° C. for about 5 to 30 minutes. Here, the above temperature must be lower than the melting point of each of the porous supports.

Finally, in the step of drying the first porous support and the second porous support on which the first porous support is added, primary drying may be performed at 60° C. to 150° C. for 15 minutes to 1 hour, and secondary drying may be performed at 150° C. to 190° C. for 3 minutes to 1 hour. Specifically, the primary drying may be performed at 60° C. to 120° C. for 15 minutes to 1 hour, and the secondary drying may be performed at 170° C. to 190° C. for 3 minutes to 1 hour. If the primary drying is performed at a temperature lower than 60° C. for less than 15 minutes, the solvent may not be primarily discharged, whereby the porous supports may not have the form of a highly dense film. If the secondary drying is performed at a temperature higher than 190° C. for more than 1 hour, the sulfonic acid group may be decomposed, whereby the performance of the membrane may be deteriorated.

According to another embodiment of the present disclosure, there are provided a membrane-electrode assembly and a fuel cell including the polymer electrolyte membrane.

Specifically, the membrane-electrode assembly includes an anode and a cathode, located opposite each other, and the polymer electrolyte membrane, located between the anode and the cathode. The membrane-electrode assembly is identical to a general membrane-electrode assembly for fuel cells except that the polymer electrolyte membrane according to the present disclosure is used as the polymer electrolyte membrane, and therefore a detailed description thereof will be omitted from this specification.

In addition, the fuel cell is identical to a general fuel cell except that the membrane-electrode assembly is included, and therefore a detailed description thereof will be omitted from this specification.

Hereinafter, examples of the present disclosure will be described in detail with reference to the accompanying drawings such that the examples of the present disclosure can be easily implemented by a person having ordinary skill in the art to which the present disclosure pertains. However, the present disclosure may be realized in various different forms, and is not limited to the examples described herein.

### Manufacturing Example 1: Manufacture of Polymer Electrolyte Membrane

### Example 1

A first porous support (e-PTFE, pore size: 0.10 μm to 0.15 μm, thickness: 6 μm, and ratio between MD tensile elongation and TD tensile elongation: 1.1) was wetted in a first ion conductor dispersion liquid including 20 wt % of a highly fluorinated polymer having an equivalent weight (EW) of 800 g/eq.

A second porous support (e-PTFE, pore size: 0.10 μm to 0.15 μm, thickness: 6 μm, and ratio between MD tensile elongation and TD tensile elongation: 1.1) was added on the first porous support while the first porous support was wetted.

A second ion conductor dispersion liquid including 20 wt % of a highly fluorinated polymer having an equivalent weight (EW) of 800 g/eq was additionally applied onto the second porous support while the second porous support is placed on the first porous support.

Subsequently, the first porous support and the second porous support were dried at 60° C. for 1 hour and were then dried at 150° C. for 30 minutes to manufacture a polymer electrolyte membrane.

### Example 2

A first porous support (e-PTFE, pore size: 0.10 μm to 0.15 μm, thickness: 6 μm, and ratio between MD tensile elongation and TD tensile elongation: 1.2) was wetted in a first ion conductor dispersion liquid including 20 wt % of a highly fluorinated polymer having an equivalent weight (EW) of 800 g/eq.

A second porous support (e-PTFE, pore size: 0.10 μm to 0.15 μm, thickness: 6 μm, and ratio between MD tensile elongation and TD tensile elongation: 1.2) was added on the first porous support while the first porous support was wetted. At this time, the first e-PTFE support and the second e-PTFE support were stacked such that the direction in which the first e-PTFE support had been drawn and the direction in which the second e-PTFE support had been drawn perpendicularly intersected each other.

A second ion conductor dispersion liquid including 20 wt % of a highly fluorinated polymer having an equivalent weight (EW) of 800 g/eq was additionally applied onto the second porous support while the second porous support is placed on the first porous support.

Subsequently, the first porous support and the second porous support were dried at 60° C. for 1 hour and were then dried at 150° C. for 30 minutes to manufacture a polymer electrolyte membrane.

### Comparative Example 1

Two porous supports (e-PTFE, pore size: 0.10 μm to 0.15 μm, thickness: 6 μm, and ratio between MD tensile elongation and TD tensile elongation: 1.1) were impregnated with an ion conductor dispersion liquid including 20 wt % of a highly fluorinated polymer having an equivalent weight (EW) of 800 g/eq. Subsequently, the two porous supports were dried at 60° C. for 1 hour and were then dried at 120° C. for 30 minutes to manufacture two polymer electrolyte membranes.

The two manufactured polymer electrolyte membranes were thermally pressed under conditions of 160° C. and 1.2 tons to manufacture a stacked polymer electrolyte membrane.

### Comparative Example 2

A polytetrafluoroethylene adhesive was applied between two porous supports (e-PTFE, pore size: 0.10 μm to 0.15 μm, thickness: 6 μm, and ratio between MD tensile elongation and TD tensile elongation: 1.1), and then the two porous supports were heated and pressed at a temperature of 340° C. and a pressure of 0.27 MPA for 30 seconds such that the two porous supports were bonded to each other to manufacture a bonded type porous support.

The manufactured bonded type porous support was impregnated with an ion conductor dispersion liquid including 20 wt % of a highly fluorinated polymer having an equivalent weight (EW) of 800 g/eq. Subsequently, the bonded type porous support was dried at 60° C. for 1 hour and was then dried at 150° C. for 30 minutes to manufacture a polymer electrolyte membrane.

### Comparative Example 3

A porous support (e-PTFE, pore size: 0.10 μm to 0.15 μm, thickness: 15 μm, and ratio between MD tensile elongation and TD tensile elongation: 1.5) was impregnated with an ion conductor dispersion liquid including 20 wt % of a highly fluorinated polymer having an equivalent weight (EW) of 800 g/eq. Subsequently, the porous support was dried at 60° C. for 1 hour and was then dried at 150° C. for 30 minutes to manufacture a polymer electrolyte membrane.

### Experimental Example 1: Measurement of Characteristics of Manufactured Polymer Electrolyte Membranes

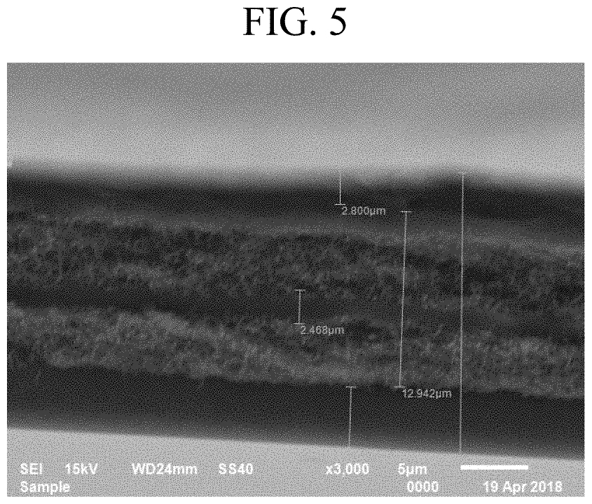

Scanning electron microscopy photographs of the polymer electrolyte membranes manufactured according to Example 1 and Comparative Example 1 are shown in FIGS. 4 and 5, respectively.

Referring to FIG. 4, it can be seen that the polymer electrolyte membrane manufactured according to Example 1 was well bonded to the extent to which not only the interface between the first and second ion conductors but also the interface between the first and second porous supports was not visible.

In addition, it can be seen that the first and second porous supports were in contact with each other and any layer consisting of an ion conductor alone was not present therebetween.

Referring to FIG. 5, on the other hand, in the case of the polymer electrolyte membrane manufactured according to Comparative Example 1, a layer consisting of an ion conductor alone was present between the first porous support and the second porous support, and the thickness of the layer was 2 μm.

### Experimental Example 2: Measurement of Physical Properties of Manufactured Polymer Electrolyte Membranes

The IP proton conductivity, TP proton conductivity, swelling ratio, tensile strength, and tensile elongation of each of the polymer electrolyte membranes manufactured according to the examples and the comparative examples were measured, and the results are shown in Table 1 below.

The IP proton conductivity was calculated by using membrane resistance at a relative humidity of 50% after measuring membrane resistance at a temperature of 80° C. and a relative humidity of 30% to 95% using a magnetic suspension balance (Bell Japan Company). At this time, the effective area of the membrane was 0.75 cm².

The TP proton conductivity was measured by coating opposite surfaces of the manufactured polymer electrolyte membrane with Pt catalyst ink, placing and fastening a gas diffusion layer (GDL) thereon, measuring membrane resistance at a temperature of 80° C. and a relative humidity (RH) of 50%, and dividing the measured membrane resistance by the thickness of the polymer electrolyte membrane.

As to the swelling ratio, a thickness swelling ratio and a length swelling ratio were calculated by immersing the manufactured polymer electrolyte membrane in distilled water of room-temperature for 12 hours, taking the polymer electrolyte membrane of a wet state out of the distilled water, measuring the thickness, the machine-direction (MD) length, and the transverse-direction (TD) length of the wet polymer electrolyte membrane, drying the polymer electrolyte membrane in a vacuum state at 50° C. for 24 hours, measuring the thickness, the machine-direction (MD) length, and the transverse-direction (TD) length of the dried polymer electrolyte membrane, and putting the thickness T_{wet} and the length L_{wet} of the polymer electrolyte membrane of the wet state and the thickness T_{dry} and the length L_{dry} of the polymer electrolyte membrane of the dry state in the Equations 1 and 2 above.

The tensile strength and the tensile elongation were measured by stretching a polymer electrolyte membrane having an area of 3 cm² in the machine direction (MD) or the transverse direction (TD) at a crosshead speed of 500 mm/sec using a 1 kN load cell.

TABLE 1

| | | | Comparative | Comparative | Comparative |
|---|---|---|---|---|---|
| | Example 1 | Example 2 | Example 1 | Example 2 | Example 3 |
| IP proton conductivity | 0.048 | 0.046 | 0.050 | 0.048 | 0.050 |
| (S/cm, RH 50%) | | | | | |
| TP proton conductivity | 0.045 | 0.042 | 0.028 | 0.021 | 0.038 |
| (S/cm, RH 50%) | | | | | |
| Ratio between IP proton | 1.06 | 1.09 | 1.79 | 2.29 | 1.32 |
| conductivity and TP proton | | | | | |
| conductivity | | | | | |
| Tensile strength (MPa) | 74/72 | 48/44 | 36/20 | 46/30 | 35/25 |
| (TD/MD) | | | | | |
| Tensile elongation (%) | 74/108 | 113/164 | 38/133 | 30/118 | 30/120 |
| (TD/MD) | | | | | |
| Ratio between TD tensile | 1.46 | 1.45 | 3.50 | 3.93 | 4 |
| elongation and MD tensile | | | | | |
| elongation | | | | | |
| Swelling ratio (%) | 0/0/6 | 2/2/24 | 9/3/23 | 10/2/26 | 10/3/25 |
| (MD/TD/Thickness) | | | | | |
| Hydrogen crossover | 5.0 × 10⁻⁵ | 4.8 × 10⁻⁵ | 5.0 × 10⁻⁵ | 4.8 × 10⁻⁵ | 7.3 × 10⁻⁵ |
| (cm²/sec) | | | | | |

Referring to Table 1 above, it can be seen that, in the case of the polymer electrolyte membrane manufactured according to each of the examples, the surface area of the porous support that directly contacted the ion conductor when the porous support was impregnated with the ion conductor was increased, whereby wetting of the porous support due to the solution including the ion conductor was improved, air in pores of the porous support was more easily discharged therefrom when the pores were filled with the ion conductor, whereby generation of microscopic air bubbles was minimized, and therefore impregnation was improved. Consequently, it can be seen that the ratio between the IP proton conductivity and the TP proton conductivity was nearly 1.

Also, in the case of the polymer electrolyte membrane manufactured according to each of the examples, an area capable of buffering dimensional change was increased, since the stacked porous support was included, whereby dimensional stability was also improved. In addition, when observing variation in dimensional stability, it can be seen that there was no substantial difference in MD/TD variation, i.e. the polymer electrolyte membrane was isotropic.

1. A polymer electrolyte membrane comprising:
a first porous support having first pores filled with a first ion conductor; and
a second porous support having at least one second pore filled with the first ion conductor and third pores filled with a second ion conductor, wherein
the first and second porous supports are in contact with each other.

2. The polymer electrolyte membrane according to claim 1, wherein all pores of the first porous support are filled with the first ion conductor.

3. The polymer electrolyte membrane according to claim 1, wherein the first porous support further has at least one fourth pore filled with the second ion conductor.

4. The polymer electrolyte membrane according to claim 1, wherein each of the first and second porous supports is an isotropic porous support configured such that machine-direction (MD) tensile elongation and transverse-direction (TD) tensile elongation are equal to each other or the higher of the MD tensile elongation and the TD tensile elongation is 1.5 times or less the lower thereof.

5. The polymer electrolyte membrane according to claim 1, wherein the first and second porous supports are stacked such that directions in which the first and second porous supports haven been drawn are perpendicular to each other.

6. A polymer electrolyte membrane comprising a porous support and an ion conductor with which pores of the porous support are filled, wherein
at a temperature of 80° C. and a relative humidity (RH) of 50%, the polymer electrolyte membrane has an in-plane (IP) proton conductivity of 0.046 S/cm to 0.1 S/cm and a through-plane (TP) proton conductivity of 0.042 S/cm to 0.1 S/cm, and
each of an MD swelling ratio and a TD swelling ratio of the polymer electrolyte membrane calculated by Equation 1 and Equation 2 below after the polymer electrolyte membrane is immersed in distilled water of room-temperature for 12 hours and then dried in a vacuum state at 50° C. for 24 hours is 2% or less.
ΔL(MD)=[(L_{wet}(MD)−L_{dry}(MD))/L_{dry}(MD)]×100 [Equation 1]
ΔL(TD)=[(L_{wet}(TD)−L_{dry}(TD))/L_{dry}(TD)]×100 [Equation 2]
where ΔL(MD) is an MD swelling ratio, ΔL(TD) is a TD swelling ratio, L_{wet}(MD) and L_{wet}(TD) are an MD length and a TD length measured immediately before the drying, respectively, and L_{dry}(MD) and L_{dry}(TD) are an MD length and a TD length measured immediately after the drying, respectively.

7. The polymer electrolyte membrane according to claim 6, wherein the TP proton conductivity and the IP proton conductivity of the polymer electrolyte membrane are equal to each other, or the higher of the TP proton conductivity and the IP proton conductivity is 1.5 times or less the lower thereof.

8. The polymer electrolyte membrane according to claim 6, wherein the TP swelling ratio and the MD swelling ratio are equal to each other, or the higher of the TP swelling ratio and the MD swelling ratio is 1.5 times or less the lower thereof.

9. The polymer electrolyte membrane according to claim 6, wherein the polymer electrolyte membrane has a hydrogen crossover of 7×10⁻⁵ cm²/sec or less at a temperature of 65° C. and a relative humidity (RH) of 50%.

10. The polymer electrolyte membrane according to claim 6, wherein MD tensile strength and TD tensile strength of the polymer electrolyte membrane are equal to each other, or the higher of the MD tensile strength and the TD tensile strength is 1.5 times or less the lower thereof.

11. The polymer electrolyte membrane according to claim 6, wherein MD tensile elongation and TD tensile elongation of the polymer electrolyte membrane are equal to each other, or the higher of the MD tensile elongation and the TD tensile elongation is 1.5 times or less the lower thereof.

12. A method of manufacturing a polymer electrolyte membrane, the method comprising:
casting a first mixed liquid comprising a first ion conductor;
placing a first porous support of a dry state on the first mixed liquid such that the first porous support is entirely brought into a wet state;
adding a second porous support of a dry state on the first porous support immediately after the first porous support is entirely brought into the wet state such that the first and second porous supports are in contact with each other;
applying a second mixed liquid comprising a second ion conductor onto the second porous support such that the second porous support is entirely brought into a wet state; and
drying the first and second porous supports of the wet state.

13. A membrane-electrode assembly comprising:
an anode and a cathode located opposite each other; and
the polymer electrolyte membrane according to claim 1, the polymer electrolyte membrane being located between the anode and the cathode.

14. A fuel cell comprising the membrane-electrode assembly according to claim 13.
